(19) United States
(12) Patent Application Publication
(10) Pub. No.: US 2014/0279939 A1
(43) Pub. Date: Sep. 18, 2014

(54) METHOD FOR PROPAGATING INFORMATION BETWEEN A BUILDING INFORMATION MODEL AND A SPECIFICATION DOCUMENT

(71) Applicant: ITI - INNOVATIVE TECHNOLOGY INC., Ottawa (CA)

(72) Inventor: Michael E. Thornber, Ottawa (CA)

(73) Assignee: ITI - INNOVATIVE TECHNOLOGY INC., Ottawa (CA)

(21) Appl. No.: 13/833,790

(22) Filed: Mar. 15, 2013

(51) Int. Cl. G06F 17/30

(52) U.S. Cl. CPC G06F 17/30371
USPC 707/690

(57) ABSTRACT

A method includes receiving, at a computer system, data exported from a Building Information Model (BIM). The exported data is indicative of a first plurality of sets of units and values, each set associated uniquely with a different element defined in the BIM. The computer system parses a specification document to identify a second plurality of sets of units and values, each set associated uniquely with a different element listed in the specification document. The computer system compares the first plurality of sets of units and values to the second plurality of sets of units and values, and automatically identifies a set of units and values that is a member of only one of the first plurality of sets of units and values and the second plurality of sets of units and values. An inconsistency between the elements listed in the specification document and the elements defined in the BIM is registered automatically.

### FIELD OF THE INVENTION

The invention relates generally to Building Information Models and specification documents associated with construction projects, and more particularly to a computer-aided method for propagating information between a Building Information Model and a specification document.

### BACKGROUND OF THE INVENTION

A construction or renovation project is a collaborative effort that requires the collective skills of a number of different professionals and workers. Architects, engineers, designers, contractors and owners are all involved at various stages of the project, sometimes having very little direct communication with one another. Of course, a building is a complex structure that is constructed using a variety of components including, e.g., windows, doors, heating/ventilation/air conditioning (HVAC) systems, electrical systems, plumbing systems, etc. The various components of the building must be selected and assembled together correctly, as specified by an overall plan for the project, and in accordance with accepted building practices and building codes. It is therefore common practice to produce drawings, models and specifications describing the work that is to be performed and the components that are to be used. Such documents are utilized by the various professionals and workers during all stages of the project, and are largely responsible for the successful outcome of the project.

The use of computer-aided design and building-information-modeling processes has been gaining popularity in recent years. A Building Information Model (BIM) describes a building structure or topology (e.g., walls, doors, elevators, stairwells, location, shape and boundaries of the compartments, etc.) as semantic objects grouped into standard classes. Each class of objects has standard properties such as physical dimensions, but can also be assigned special properties such as the R-values for windows and doors, fire ratings for doors and walls, and trafficability of a space. Such BIM information can be used to rapidly and automatically generate 3D graphical renderings of buildings, as well as in a range of other applications from energy management to evacuation planning.

Building information models are typically described as assemblies, based on internationally recognized standards of classification such as UniFormat, MasterFormat or OmniClass, among others. Such classification systems provide a consistent way to define building model elements, regardless of the complexities of the assemblies or model elements that they represent. It is also a very logical way to categorize building model elements, in which the components of the building are described as assemblies rather than constituent parts.

Specification documents, on the other hand, have been around for many years and little has changed in the way they are prepared. Specifications are written in a linear way, and are structured according to products, activities or construction requirements. For instance, in North America specifications are based on MasterFormat, a 50-division, material-specific organizational format which, according to the Construction Specifications Institute (CSI), is an “organizational standard for specifications and is a master list of titles and numbers classified by work results for organizing data about construction requirements, products, and activities.” The specification document is written by a specification writer and reflects a myriad of decisions that have been made during the design process regarding the components of the building, such as for instance the specific type of each of the components and the number of units of each type of component required, etc. Commercial master specifications currently are provided as word processing files or as a database file. Each word processing file is a separate specification section. In the database iteration, the entire specification is stored in one file. In both cases, the user edits the contents of the master specification to achieve the appropriate information for the project at hand.

As will be apparent, it is important to maintain consistency between the BIM data and the specification document since discrepancies may result in construction errors. At the same time, it is sometimes necessary to modify a project after it has started, which may result in changes being made to the BIM data and/or to the specification document. For instance, changes may be made to the BIM data in order to accommodate new design preferences or to replace one component with another component having different characteristics, etc. Similarly, changes may be made to the specification document if unexpected problems are encountered during performance of the work, etc.

Although the format of the specification document is standardized, each different BIM design tool currently on the market has its own data format. As a result, propagating information between the BIM data and the specification document when changes are made is largely a manual process and therefore prone to error. Even if the information is propagated error free, the manual nature of the process tends to result in less frequent updating, which may lead to mismatches between the information in the BIM and the information in the specification document during certain periods of time. Further, many of the properties that the specification writer will be including in the specification document have already been outlined in the BIM, leading to an unnecessary duplication of effort when the specification writer re-enters the same data in the specification document. There currently exists no generally applicable solution for propagating information between BIM design tools and a specification document in an automated fashion.

It would be beneficial to overcome at least some of the above-mentioned limitations and disadvantages of the prior art.

### SUMMARY OF THE INVENTION

In accordance with an aspect of at least one embodiment of the instant invention, there is provided a computer-aided method for propagating information between a building information model (BIM) and a specification document associated with a project, comprising: receiving, at a computer system, data exported from the BIM, the exported data indicative of a first plurality of sets of units and values, each one of the first plurality of sets of units and values being associated uniquely with a different element that is defined in the BIM; parsing, by the computer system, the specification document to identify a second plurality of sets of units and values, each one of the second plurality of sets of units and values being associated uniquely with a different element that is listed in the specification document; comparing, by the computer system, the first plurality of sets of units and values to the second plurality of sets of units and values; based on a result of the comparing, automatically identifying a set of units and values that is a member of only one of the first plurality of sets of units and values and the second plurality of sets of units and values; and automatically registering an inconsistency between the elements that are listed in the specification document and the elements that are defined in the BIM, the inconsistency relating to a known element that is associated with the identified set of units and values.

In accordance with an aspect of at least one embodiment of the instant invention, there is provided a computer-aided method for propagating information between a building information model (BIM) and a specification document associated with a project, comprising: parsing, by a computer system, the specification document to identify a set of units and values that is associated uniquely with a known element listed in the specification document; receiving, at the computer system, data exported from the BIM, the exported data indicative of a plurality of unique sets of units and values, each one of the plurality of unique sets of units and values associated with a different element of a plurality of elements that is defined in the BIM; automatically searching within the exported data for a set of units and values that is a match to the set of units and values that is associated uniquely with the known element; and when a result of the searching does not identify a set of units and values within the exported data that is a match to the set of units and values that is associated uniquely with the known element, registering an inconsistency between the specification document and the BIM, the inconsistency relating to the known element.

In accordance with an aspect of at least one embodiment of the instant invention, there is provided a non-transitory computer-readable medium storing computer-readable instructions for implementing a method for propagating information between a building information model (BIM) and a specification document associated with a project, the method comprising: receiving data exported from the BIM, the exported data indicative of a first plurality of sets of units and values, each one of the first plurality of sets of units and values being associated uniquely with a different element that is defined in the BIM; parsing the specification document to identify a second plurality of sets of units and values, each one of the second plurality of sets of units and values being associated uniquely with a different element that is listed in the specification document; comparing the first plurality of sets of units and values to the second plurality of sets of units and values; based on a result of the comparing, automatically identifying a set of units and values that is a member of only one of the first plurality of sets of units and values and the second plurality of sets of units and values; and automatically registering an inconsistency between the elements that are listed in the specification document and the elements that are defined in the BIM, the inconsistency relating to a known element that is associated with the identified set of units and values.

### BRIEF DESCRIPTION OF THE DRAWINGS

The instant invention will now be described by way of example only, and with reference to the attached drawings, wherein similar reference numerals denote similar elements throughout the several views, and in which:

FIG. 1 is a simplified block diagram of a system for implementing embodiments of the invention.

FIG. 2 is a simplified flow diagram of a method according to an embodiment of the invention.

FIG. 3 is a simplified flow diagram of a method according to an embodiment of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Throughout the description and in the appended claims, the term “UniFormat” is intended to encompass variants including but not limited to the following: “UniFormat,” “UniFormat II,” “UniFormat 2010,” “GSA UniFormat,” “ASTM UniFormat” and “R.S. Means UniFormat” or any other similar standard.

With reference to FIG. 1, shown is a simplified block diagram of a representative system for implementing embodiments of the invention. System 100, which may be a general-purpose or special-purpose computer or any one of a variety of other consumer electronic devices, includes processing system 102 and memory 104. Other components of system 100 include one or more mass storage devices 106, input device 108, and output device 110, each of which is discussed in more detail below. Optionally, system 100 is in communication with other remote or local systems via a communication network, such as a Local Area Network (LAN) and/or a Wide Area Network (WAN).

Processing system 102 includes one or more processors, such as a central processor and optionally one or more other processors designed to perform a particular function or task. It is typically the processing system 102 that executes instructions provided on computer-readable media, such as on memory 104, a magnetic hard disk, a removable magnetic disk, a magnetic cassette, an optical disk, or from a communication connection, which may also be viewed as a computer-readable medium.

Memory 104 includes one or more computer-readable media that may be configured to include or includes thereon data or instructions for manipulating data, and may be accessed by processing system 102. Mass storage device 106 provides non-volatile storage of data and/or executable instructions that may include one or more program modules such as an operating system, one or more application programs, other program modules, or program data. Such executable instructions are examples of program code for implementing steps for methods disclosed herein.

The system 100 includes one or more input devices 108 to enable a user to enter data and/or instructions. Examples of such input devices include a keyboard and alternate input devices, such as a mouse, trackball, stylus, touchscreen, or other pointing device, etc. Additionally, the system 100 includes one or more output devices 110 for providing human intelligible information to the user. Examples of output devices include a monitor or display screen, a speaker, a printer, and the like.

As noted above, optionally the system 100 is in communication with other systems via a communication network, such as for instance the Internet. In a networked system, accessible program modules or portions thereof may be stored in a remote memory storage device. As such, the system 100 may participate in a distributed computing environment, where functions or tasks are performed by a plurality of networked devices.

Referring now to FIG. 2, shown is a simplified flow diagram of a method according to an embodiment of the invention. More particularly, FIG. 2 depicts a computer-aided method for propagating information between a building information model (BIM) and a specification document associated with a project. The BIM is a data file, which is created using computer aided design software such as for instance the Revit® products that are offered by Autodesk®. The specification document is for instance a word processing file or a database file. Both the BIM and the specification document are created during the planning and design stage of the project, and either one may be changed during the course of the project in response to design changes or in the event that unexpected problems are encountered, etc.

At 200, data exported from the BIM is received at a computer system, such as for instance the system 100 of FIG. 1. In this specific example, it is assumed that the data is exported from the BIM in the Industry Foundation Classes (IFC) data format. The exported data is indicative of a first plurality of sets of units and values, each one of the first plurality of sets of units and values being associated uniquely with a different element that is defined in the BIM. For instance, the element defined in the BIM is a window and the set of units and values associated uniquely with that window specify the dimensions of the window, the R-value of the window, etc. Properties of the elements in the BIM are grouped with their elements in a tabular format in such way that, when the tabular data is gathered in the IFC file, it is readily accessible, i.e. the property data are attached to particular instances of building elements so that the data appears as lists of properties.

The specification data is not arranged in a tabular format, and must be parsed from the textual data contained in appropriately numbered specification sections. Unfortunately, the sections of the specification document are numbered according to the MasterFormat classification standard whereas the building elements defined in the BIM are numbered according to the UniFormat classification standard. The use of different classification standards for the specification document and the BIM results in uncertainties when the UniFormat-numbered building elements are being matched with the corresponding specification sections. Such uncertainties may be resolved using one of the methods that are described in the commonly assigned and co-pending application entitled “Method For Mapping Elements Of A Construction Project,” the entire contents of which are incorporated herein by reference.

Once the appropriate UniFormat number is determined, then at 202 the “Part 2—Products” portion of the specification document is parsed by the computer system to identify a second plurality of sets of units and values, each one of the second plurality of sets of units and values being associated uniquely with a different element that is listed in the specification document. At 204, using the software application in execution on the computer system, the first plurality of sets of units and values is compared to the second plurality of sets of units and values. At 206 it is determined, based on a result of the comparison, whether or not the first plurality of sets of units and values is identical to the second plurality of sets of units and values. If identical, then at 208 the method terminates. Optionally, the method repeats as indicated using the dashed line in FIG. 2. In this case, the BIM and the specification document are consistent one with the other. Alternatively, if not identical, then at 210 a set of units and values that is a member of only one of the first plurality of sets of units and values and the second plurality of sets of units and values is identified automatically, based on a result of the comparing. At 212 an inconsistency is automatically registered between the elements that are listed in the specification document and the elements that are defined in the BIM. In particular, the inconsistency relates to a known element that is associated with the identified set of units and values. The method terminates at 208. Optionally, the method repeats as indicated using the dashed line in FIG. 2.

The determination that is made at 206, as to whether or not the first plurality of sets of units and values is identical to the second plurality of sets of units and values, does not strictly require each set of the first plurality to have an exactly matching set of the second plurality. That is to say, in the BIM an element may have associated therewith a first set of units and values and in the specification document the same element may have associated therewith a second set of units and values that has either more or fewer units and values than the first set. Provided the first and second sets of units and value are sufficiently unique to identify the element, then it is possible to determine based on the first and second sets that the BIM and the specification document are consistent with respect to that element. For clarity, the comparison at 204 and the determination at 206 use the sets of units and values associated with different elements to determine if any of the elements are present in one of the BIM and the specification document but not in the other of the BIM and the specification document. Using the specific and non-limiting example of a window, an inconsistency with respect to the window may be determined if the BIM specifies a first R-value for a window having specific dimensions and the specification document specifies a second R-value for a window having the same specific dimensions. When identified at 210, the inconsistency is subsequently registered at 212 which optionally includes providing a human-intelligible indication relating to the inconsistency with respect to the window, such as for instance via output device 110 of system 100. A user of the system 100 provides an input via input device 109 for resolving the inconsistency. For instance, the user provides an input indicative of the one of the BIM and the specification document that is to be updated to resolve the inconsistency relating to the window in this example. Based on the input from the user, the system 100 automatically propagates the relevant information to the one of the BIM and the specification document that is to be updated, such that the BIM and the specification document are consistent with respect to the window in this example. Updating one of the BIM and the specification document, based on the input from the user, may include either adding information relating to the element to the one of the BIM and the specification document or deleting information relating to the element to the one of the BIM and the specification document.

In general, the above-mentioned sets of units and values optionally include one or more of the following types of units, e.g., linear measurement units, pressure units, fire-resistance rating units, insulation value units, energy consumption units, heating/cooling units, or fluid flow units. Further optionally, the above-mentioned sets of units and values include values relating to at least one of the following characteristic properties of the elements: color, water resistance treatment, material, finish or order of completion in the project.

Referring now to FIG. 3, shown is a simplified flow diagram of a method according to an embodiment of the invention. More particularly, FIG. 3 depicts a computer-aided method for propagating information between a building information model (BIM) and a specification document associated with a project. As discussed previously with reference to FIG. 2, the BIM is a data file, which is created using computer aided design software such as for instance the Revit® products that are offered by Autodesk®. The specification document is for instance a word processing file or a database file. Both the BIM and the specification document are created during the planning and design stage of the project, and either one may be changed during the course of the project in response to design changes or in the event that unexpected problems are encountered, etc.

At 300, the specification document is parsed by a computer system, such as for instance the system 100 of FIG. 1, to identify a set of units and values that is associated uniquely with a known element listed in the specification document. For instance, the known element defined in the specification document is a window and the set of units and values associated uniquely with that window specify the dimensions of the window, the R-value of the window, etc. As discussed previously with reference to FIG. 2, the specification data is not arranged in a tabular format, and must be parsed from the textual data contained in appropriately numbered specification sections.

At 302, data exported from the BIM is received at the computer system. In this specific example, it is assumed that the data is exported from the BIM in the Industry Foundation Classes (IFC) data format. The data exported from the BIM is indicative of a plurality of unique sets of units and values, each one of the plurality of unique sets of units and values associated with a different element of a plurality of elements that is defined in the BIM. More particularly, a software application in execution on the computer system receives the data exported from the BIM and also parses the specification document. At 304, using the software application in execution on the computer system, searching is performed within the exported data to identify a set of units and values that is a match to the set of units and values associated uniquely with the known element defined in the specification document. At decision 306, when a result of the searching identifies a set of units and values within the exported data that is a match to the set of units and values that is associated uniquely with the known element, then at 308 the method terminates. Optionally, the method repeats as indicated using the dashed line in FIG. 3. At decision 306, when a result of the searching does not identify a set of units and values within the exported data that is a match to the set of units and values associated uniquely with the known element, then at 310 an inconsistency between the specification document and the BIM is registered automatically. In particular, the registered inconsistency relates to the known element that is defined in the specification document but not in the BIM.

As noted previously with reference to FIG. 2, the sections of the specification document are numbered according to the MasterFormat classification standard whereas the building elements defined in the BIM are numbered according to the UniFormat classification standard. Uncertainties that arise when information in one of the classification standards is matched with information in the other of the classification standards may be resolved using one of the methods that are described in the commonly assigned and co-pending application entitled “Method For Mapping Elements Of A Construction Project.”

Optionally, a human-intelligible indication relating to the inconsistency is provided, such as for instance via output device 110 of system 100. A user of the system 100 provides an input via input device 109 for resolving the inconsistency. For instance, the user provides an input indicative of the one of the BIM and the specification document that is to be updated to resolve the inconsistency relating to the window in this example. Based on the input from the user, the system 100 automatically propagates the relevant information to the one of the BIM and the specification document that is to be updated, such that the BIM and the specification document are consistent with respect to the known element. Updating one of the BIM and the specification document, based on the input from the user, may include either adding information relating to the element to the one of the BIM and the specification document or deleting information relating to the element to the one of the BIM and the specification document.

In general, the above-mentioned sets of units and values optionally include one or more of the following types of units, e.g., linear measurement units, pressure units, fire-resistance rating units, insulation value units, energy consumption units, heating/cooling units, or fluid flow units. Further optionally, the above-mentioned sets of units and values include values relating to at least one of the following characteristic properties of the elements: color, water resistance treatment, material, finish or order of completion in the project.

The methods that are described with reference to FIGS. 2 and 3 support automated propagation of information between a BIM and a specification document for a construction project, in a software-independent fashion. Packaging the BIM data in a tabular or sentence format supports building/modifying the specification document directly. Optionally, a feedback loop is established to ensure consistency between the BIM and the specification and between the specification and the BIM, such that both views of the design are consistent and updated.

While the above description constitutes a plurality of embodiments of the present invention, it will be appreciated that the present invention is susceptible to further modification and change without departing from the fair meaning of the accompanying claims.

What is claimed is:

1. A computer-aided method for propagating information between a building information model (BIM) and a specification document associated with a project, comprising:
receiving, at a computer system, data exported from the BIM, the exported data indicative of a first plurality of sets of units and values, each one of the first plurality of sets of units and values being associated uniquely with a different element that is defined in the BIM;
parsing, by the computer system, the specification document to identify a second plurality of sets of units and values, each one of the second plurality of sets of units and values being associated uniquely with a different element that is listed in the specification document;
comparing, by the computer system, the first plurality of sets of units and values to the second plurality of sets of units and values;
based on a result of the comparing, automatically identifying a set of units and values that is a member of only one of the first plurality of sets of units and values and the second plurality of sets of units and values; and
automatically registering an inconsistency between the elements that are listed in the specification document and the elements that are defined in the BIM, the inconsistency relating to a known element that is associated with the identified set of units and values.

2. The computer-aided method of claim 1 wherein the BIM data is exported in the Industry Foundation Classes (IFC) data format.

3. The computer-aided method of claim 1 comprising updating one of the BIM and the specification document to resolve the inconsistency relating to the known element.

4. The computer-aided method of claim 3 wherein updating comprises adding, to the one of the BIM and the specification document, data relating to the known element and comprising the set of units and values that is associated uniquely with the known element.

5. The computer-aided method of claim 3 wherein updating comprises deleting, from the one of the BIM and the specification document, data relating to the known element and comprising the set of units and values that is associated uniquely with the known element.

6. The computer-aided method of claim 3 wherein updating is based on an input provided from a user of the computer system, the input indicative of the one of the BIM and the specification document that is to be updated to resolve the inconsistency relating to the known element.

7. The computer-aided method of claim 1 wherein the sets of units and values of the first plurality of sets of units and values and of the second plurality of sets of units and values are based on characteristic properties of the elements that are defined in the BIM and the elements that are listed in the specification document, respectively.

8. The computer-aided method of claim 7 wherein the sets of units and values includes units selected from the group consisting of: linear measurement units, pressure units, fire-resistance rating units, insulation value units, energy consumption units, heating/cooling units, and fluid flow units.

9. The computer-aided method of claim 7 wherein the sets of units and values includes values relating to at least one of the following characteristic properties of the elements: color, water resistance treatment, material, finish and order of completion in the project.

10. A computer-aided method for propagating information between a building information model (BIM) and a specification document associated with a project, comprising:
parsing, by a computer system, the specification document to identify a set of units and values that is associated uniquely with a known element listed in the specification document;
receiving, at the computer system, data exported from the BIM, the exported data indicative of a plurality of unique sets of units and values, each one of the plurality of unique sets of units and values associated with a different element of a plurality of elements that is defined in the BIM;
automatically searching within the exported data for a set of units and values that is a match to the set of units and values that is associated uniquely with the known element; and
when a result of the searching does not identify a set of units and values within the exported data that is a match to the set of units and values that is associated uniquely with the known element, registering an inconsistency between the specification document and the BIM, the inconsistency relating to the known element.

11. The computer-aided method of claim 10 wherein the BIM data is exported in the Industry Foundation Classes (IFC) data format.

12. The computer-aided method of claim 10 comprising updating one of the BIM and the specification document to resolve the inconsistency relating to the known element.

13. The computer-aided method of claim 12 wherein updating comprises adding, to the BIM, data relating to the known element and the set of units and values that is associated uniquely with the known element.

14. The computer-aided method of claim 12 wherein updating comprises deleting, from the specification document, data relating to the known element and the set of units and values that is associated uniquely with the known element.

15. The computer-aided method of claim 12 wherein updating is based on an input provided from a user of the computer system, the input indicative of the one of the BIM and the specification document that is to be updated to resolve the inconsistency relating to the known element.

16. The computer-aided method of claim 10 wherein the set of units and values that is associated uniquely with the known element is determined based on characteristic properties of the known element.

17. The computer-aided method of claim 16 wherein the set of units and values includes units selected from the group consisting of: linear measurement units, pressure units, fire-resistance rating units, insulation value units, energy consumption units, heating/cooling units, and fluid flow units.

18. The computer-aided method of claim 16 wherein the sets of units and values includes values relating to at least one of the following characteristic properties of the elements: color, water resistance treatment, material, finish and order of completion in the project.

19. A non-transitory computer-readable medium storing computer-readable instructions for implementing a method for propagating information between a building information model (BIM) and a specification document associated with a project, the method comprising:
receiving data exported from the BIM, the exported data indicative of a first plurality of sets of units and values, each one of the first plurality of sets of units and values being associated uniquely with a different element that is defined in the BIM;
parsing the specification document to identify a second plurality of sets of units and values, each one of the second plurality of sets of units and values being associated uniquely with a different element that is listed in the specification document;
comparing the first plurality of sets of units and values to the second plurality of sets of units and values;
based on a result of the comparing, automatically identifying a set of units and values that is a member of only one of the first plurality of sets of units and values and the second plurality of sets of units and values; and
automatically registering an inconsistency between the elements that are listed in the specification document and the elements that are defined in the BIM, the inconsistency relating to a known element that is associated with the identified set of units and values.

20. The non-transitory computer-readable medium of claim 19 wherein the BIM data is exported in the Industry Foundation Classes (IFC) data format.

21. The non-transitory computer-readable medium of claim 19 wherein the method further comprises updating one of the BIM and the specification document to resolve the inconsistency relating to the known element.

22. The non-transitory computer-readable medium of claim 21 wherein updating is performed based on an input provided from a user, the input indicative of the one of the BIM and the specification document that is to be updated to resolve the inconsistency relating to the known element.
